(19) United States
(12) Patent Application Publication
(10) Pub. No.: US 2020/0243877 A1
(43) Pub. Date: Jul. 30, 2020

(54) FUEL CELL SYSTEM AND METHOD OF CONTROLLING FUEL CELL SYSTEM

(71) Applicant: TOYOTA JIDOSHA KABUSHIKI KAISHA, Toyota-shi (JP)

(72) Inventor: Masaya AMANO, Toyota-shi, (JP)

(21) Appl. No.: 16/701,248

(22) Filed: Dec. 3, 2019

(30) Foreign Application Priority Data
Jan. 30, 2019 (JP) 2019-013719

(51) Int. Cl. H01M 8/04089; H01M 8/04746

(52) U.S. Cl. CPC H01M 8/04089; H01M 2250/20; H01M 8/04753

(57) ABSTRACT

A fuel cell system includes a fuel cell, a fuel gas supply unit, a leakage sensor, a speed detector, and a control device. The control device is configured to, in a case where the speed of the vehicle is greater than the threshold speed, stop supply of the fuel gas to the fuel cell when the leakage of the fuel gas is continuously sensed during a predetermined first sensing time, and in a case where the speed of the vehicle is equal to or less than the threshold speed, stop the supply of the fuel gas to the fuel cell when the leakage of the fuel gas is continuously sensed during a predetermined second sensing time that is shorter than the first sensing time.

### INCORPORATION BY REFERENCE

The disclosure of Japanese Patent Application No. 2019-013719 filed on Jan. 30, 2019 including the specification, drawings and abstract is incorporated herein by reference in its entirety.

### BACKGROUND

### 1. Technical Field

The present disclosure relates to a fuel cell system and a method of controlling the fuel cell system.

### 2. Description of Related Art

For example, Japanese Unexamined Patent Application Publication No. 2004-139842 discloses a fuel cell system mounted on a vehicle, which senses leakage of hydrogen supplied to the fuel cell as a fuel gas.

### SUMMARY

When a fuel cell system is mounted on a vehicle, for example, in a state in which an airflow is unlikely to occur inside the vehicle, such as in a state in which the vehicle is stopped, the leaked fuel gas is likely to stay in the vehicle. Therefore, when sensing of fuel gas leakage is delayed in such a state in which the airflow is unlikely to occur, hydrogen leaked in the vehicle may stay in a shorter time than when the vehicle is traveling at high speed.

A technology of the present disclosure may be implemented with below aspects.

A first aspect of the present disclosure is a fuel cell system mounted on a vehicle. The fuel cell system includes a fuel cell configured to generate power by receiving a fuel gas and an oxidant gas, a fuel gas supply unit configured to supply the fuel gas to the fuel cell, and a leakage sensor configured to sense leakage of the fuel gas, a speed detector configured to detect the speed of the vehicle, and a control device configured to control the fuel gas supply unit. The control device is configured to perform leakage sensing processing including, in a case where the speed of the vehicle is greater than the threshold speed, stopping supply of the fuel gas to the fuel cell, or reducing a supply amount of the fuel gas to the fuel cell the fuel gas leakage is continuously sensed during a predetermined first sensing time, and in a case where the speed of the vehicle is equal to or less than the threshold speed, stopping the supply of the fuel gas to the fuel cell, or reducing the supply amount of the fuel gas to the fuel cell when the fuel gas leakage is continuously sensed during a predetermined second sensing time. The second sensing time is shorter than the first sensing time.

According to the fuel cell system of the above aspect, in a situation in which the speed of the vehicle is low and the fuel gas leaked in the vehicle is likely to stay, based on a short-time determination using the second sensing time, the fuel gas supply can be stopped or the supply amount of the fuel gas can be reduced, at an earlier stage as a countermeasure against the leakage of the fuel gas. Therefore, it is possible to curb staying of the hydrogen leaked in the vehicle.

The control device may resume, after stopping the supply of the fuel gas to the fuel cell when the speed of the vehicle is equal to or less than the threshold speed and the fuel gas leakage is continuously sensed during the second sensing time, the supply of the fuel gas to the fuel cell in a case where the leakage of the fuel gas is not sensed before the time during which the leakage of the fuel gas is continuously sensed exceeds a predetermined third sensing time. The third sensing time is longer than the second sensing time.

According to the fuel cell system of the above aspect, even when the fuel gas leakage is erroneously sensed and the fuel gas supply is stopped based on the short-time determination using the second sensing time, the fuel gas supply is resumed in a case where the leakage is not sensed for a short time that does not exceed the third sensing time. Therefore, inconvenience for a user when the fuel gas supply is stopped by such erroneous leakage sensing is reduced.

The fuel cell system may further include a notification device configured to notify the user of an occurrence of the leakage of the fuel gas. The control device may perform, after stopping the supply of the fuel gas to the fuel cell when the speed of the vehicle is equal to or less than the threshold speed and the leakage of the fuel gas is continuously sensed during the second sensing time, leakage countermeasure processing that includes processing of causing the notification device to notify the occurrence of the leakage of the fuel gas in a case where the time during which the leakage of the fuel gas is continuously sensed exceeds the third sensing time.

According to the fuel cell system of the above aspect, even when the fuel gas leakage is erroneously sensed based on the short-time determination using the second sensing time, notification to the user is not performed unless the time during which the fuel gas leakage is continuously sensed exceeds the third sensing time. Therefore, it is possible to curb a situation in which the occurrence of fuel gas leakage is erroneously notified to the user.

The leakage countermeasure processing may include processing of terminating an operation of the fuel cell system.

According to the fuel cell system of the above aspect, it is possible to curb a continuous operation of the fuel cell system while the fuel gas leakage is sensed.

The fuel cell system may further include a secondary battery configured to store part of the power generated by the fuel cell. The control device may detect an acceleration operation of the vehicle by the user, perform an operation control for supplying the power in response to the acceleration operation from at least one of the fuel cell and the secondary battery to a driving power source of the vehicle, repeatedly perform the leakage sensing processing at a predetermined control cycle during the performance of the operation control, and after stopping the supply of the fuel gas to the fuel cell when the speed of the vehicle is equal to or less than the threshold speed and the leakage of the fuel gas is continuously sensed during the second sensing time, resume the supply of the fuel gas to the fuel cell in a case where the acceleration operation is detected before the time during which the leakage of the fuel gas is continuously sensed exceeds the third sensing time, to supply the power in response to the acceleration operation to the driving power source and accelerate the vehicle.

According to the fuel cell system of the above aspect, even when the fuel gas supply is stopped based on the short-time determination using the second sensing time when the speed of the vehicle is low, after the vehicle is accelerated by the user's acceleration operation, the fuel gas leakage is sensed again under a determination condition according to the speed of the vehicle. Therefore, it is possible to determine the fuel gas leakage by appropriately changing the determination condition according to the change in the speed of the vehicle. In addition, even after the gas supply is stopped, the fuel gas supply may be swiftly resumed in response to the user's acceleration operation, such that the fuel cell is swiftly returned to a normal power generation state. Therefore, a traveling period depending only on the power output from the secondary battery is reduced, and the vehicle can be smoothly accelerated.

The fuel gas supply unit includes a tank that stores the fuel gas, a main stop valve that controls an outflow of the fuel gas from the tank, and a supply device that adjusts the supply amount of the fuel gas to the fuel cell. The supply device is provided on a downstream side of the main stop valve. The control device may stop, when the speed of the vehicle is greater than the threshold speed and the leakage of the fuel gas is continuously sensed during the first sensing time, the supply of the fuel gas to the fuel cell by closing the main stop valve, and stop, when the speed of the vehicle is equal to or less than the threshold speed and the leakage of the fuel gas is continuously sensed during the second sensing time, the supply of the fuel gas to the fuel cell by stopping the operation of the supply device without closing the main stop valve.

According to the fuel cell system of the above aspect, after the fuel gas supply is stopped, when a resumption of the fuel gas supply is determined, the fuel gas supply can be resumed swiftly and easily by the resumption of the operation of the supply device. Moreover, when stopping of the fuel gas supply is determined, the main stop valve is closed based on a determination with higher accuracy using the first sensing time or the third sensing time. Therefore, an occurrence of a malfunction caused by the fuel gas leakage can be further curbed.

The state in which the speed of the vehicle is equal to or less than the threshold speed may be a state in which the vehicle is stopped, and the state in which the speed of the vehicle is greater than the threshold speed may be a state in which the vehicle is traveling.

According to the fuel cell system of the above aspect, it is possible to take a countermeasure against the fuel gas leakage at an earlier stage while the vehicle is stopped and the leaked gas is more likely to stay in the vehicle.

A second aspect of the present disclosure is a method of controlling a fuel cell system. The fuel cell system is mounted on a vehicle, and includes a fuel cell configured to generate power by receiving a fuel gas and an oxidant gas, a leakage sensor configured to sense leakage of the fuel gas, a speed detector configured to detect the speed of a vehicle, and a control device configured to control supply of fuel gas to the fuel cell. The method includes a step of detecting, by the speed detector, the speed of the vehicle, a step of sensing, by the leakage sensor, the leakage of the fuel gas, a step of, in a case where the speed of the vehicle is greater than a predetermined threshold speed, by the control device, stopping the supply of the fuel gas or reducing a supply amount of the fuel gas to the fuel cell when the fuel gas leakage is continuously sensed during a predetermined first sensing time, and a step of, in a case where the speed of the vehicle is equal to or less than the threshold speed, by the control device, stopping the supply of the fuel gas or reducing the supply amount of the fuel gas to the fuel cell when the fuel gas leakage is continuously sensed during a predetermined second sensing time. The second sensing time is shorter than the first sensing time.

The technology of the present disclosure may also be implemented in various forms in addition to the fuel cell system and the method of controlling the fuel cell system. For example, it is possible to implement the technology in forms, such as a vehicle equipped with a fuel cell system, a method of controlling a fuel gas supply unit, a countermeasure method when the fuel gas leakage is sensed, a control device or a computer program for implementing such methods, and a non-transitory recording medium recording such a computer program.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram of a fuel cell system mounted on a vehicle;

FIG. 2 is a schematic diagram illustrating an installation location of a leakage sensing unit in a vehicle;

FIG. 3 is a flowchart explaining a flow of leakage sensing processing according to a first embodiment;

FIG. 4 is a flowchart explaining a flow of leakage sensing processing according to a second embodiment; and

FIG. 5 is a flowchart explaining a flow of leakage sensing processing according to a third embodiment.

### DETAILED DESCRIPTION OF EMBODIMENTS

### First Embodiment

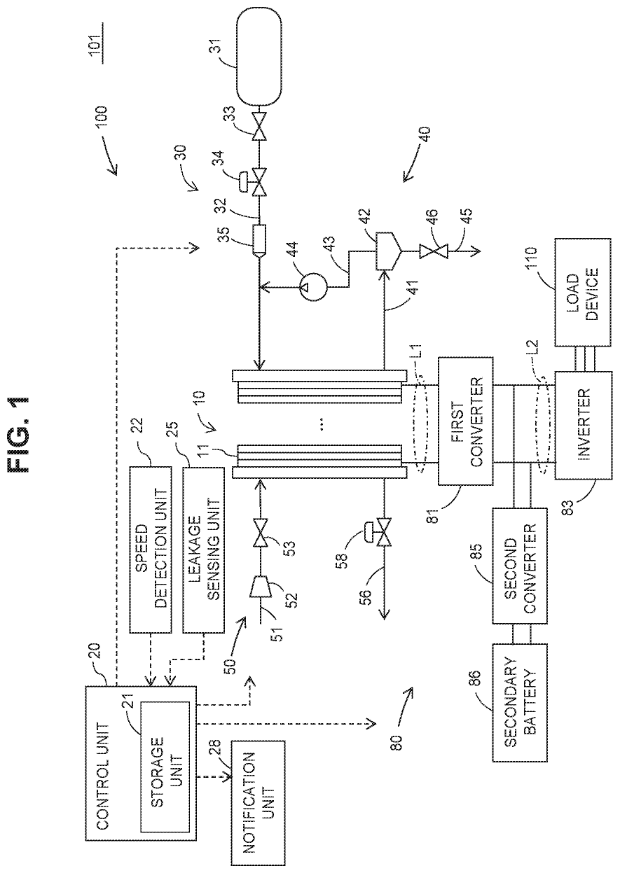

FIG. 1 is a schematic diagram illustrating a configuration of a fuel cell system 100 according to a first embodiment. The fuel cell system 100 according to the first embodiment is mounted on a vehicle 101. The fuel cell system 100 includes a fuel cell 10 that generates power by receiving a fuel gas and an oxidant gas, and supplies the power generated by the fuel cell 10 to a load device 110 mounted on the vehicle 101. The load device 110 includes, for example, a drive motor that is a driving power source, electrical component, auxiliary machinery, or connector, used for power supply from the outside, of the vehicle 101.

In the first embodiment, the fuel cell 10 is a solid polymer fuel cell that generates power by an electrochemical reaction between hydrogen as a fuel gas and oxygen as an oxidant gas. The fuel cell 10 has a stack structure in which a plurality of single cells 11 is stacked. Each of the single cells 11 is a power generation element capable of generating power even by itself, and includes a membrane electrode assembly that is a power generation body in which electrodes are arranged on both surfaces of an electrolyte membrane, and two separators that sandwich the membrane electrode assembly. The electrolyte membrane includes a solid polymer thin film that exhibits good proton conductivity in a wet state in which the electrolyte membrane contains moisture inside. An illustration of each component of the above-described single cell 11 is omitted. Moreover, the fuel cell 10 is not limited to a solid polymer electrolyte fuel cell, and various other kinds of fuel cells may be employed. In other embodiments, for example, a solid oxide fuel cell may be employed as the fuel cell 10.

The fuel cell system 100 includes a control unit 20 that controls an operation of the vehicle 101 and power generation of the fuel cell 10. The control unit 20 includes an electronic control unit (ECU) including at least one processor and a primary storage device. A processor executes a program or an instruction read on the primary storage device. As such, the control unit 20 fulfills various functions for controlling power generation of the fuel cell 10. In addition, at least part of the function of the control unit 20 may include a hardware circuit. In the first embodiment, the control unit 20 includes a storage unit 21 that stores information used for controlling in a non-volatile manner.

The control unit 20 performs an operation control detecting an acceleration operation by a user via an accelerator pedal and the like (not shown), and supplying the power in response to the acceleration operation from at least one of the fuel cell 10 and a secondary battery 86, which will be described below, to the driver motor included in the load device 110. Further, the control unit 20 performs leakage sensing processing of sensing the leakage and performing a countermeasure against leakage of the fuel gas inside the vehicle 101. The leakage sensing processing will be described below.

The fuel cell system 100 further includes a speed detection unit 22, a leakage sensing unit 25, and a notification unit 28. The speed detection unit 22 detects the current speed of the vehicle 101 and outputs the current speed to the control unit 20. As will be described below, the control unit 20 uses a detection result of the speed of the vehicle 101 in the leakage sensing processing.

The leakage sensing unit 25 senses the fuel gas leakage inside the vehicle 101. In the first embodiment, the leakage sensing unit 25 includes, for example, an oxygen detector. The leakage sensing unit 25 detects the concentration of the fuel gas in the atmosphere in the vehicle 101 and outputs the concentration to the control unit 20. When the concentration is higher than a predetermined threshold value, the control unit 20 senses an occurrence of the fuel gas leakage. When the occurrence of the fuel gas leakage is sensed, the control unit 20 measures the time during which the fuel gas leakage is continuously sensed by the leakage sensing unit 25. In the leakage detection processing, the control unit 20 determines whether or not the sensed fuel gas leakage requires a countermeasure based on the measurement time. In the first embodiment, the leakage sensing unit 25 is installed in a plurality of locations in the vehicle 101. An installation location of the leakage sensing unit 25 will be described below.

Under the control of the control unit 20, the notification unit 28 notifies the user of the vehicle 101 that a fuel gas leakage has been sensed. The notification unit 28 includes, for example, a display unit, such as a display or an indicator provided on the dashboard of the vehicle 101. The notification unit 28 may include a speaker that outputs a warning sound or audio.

The fuel cell system 100 includes a fuel gas supply unit 30, a fuel gas circulation and discharge unit 40, and an oxidant gas supply and discharge unit 50, as components that control a supply of reaction gas to the fuel cell 10. The fuel gas supply unit 30 supplies the fuel gas to the anode of the fuel cell 10. The fuel gas supply unit 30 includes a tank 31 that stores high-pressure fuel gas, a fuel gas pipe 32 that connects the tank 31 to the anode inlet of the fuel cell 10, a main stop valve 33, a regulator 34, and a supply device 35. The main stop valve 33, the regulator 34, and the supply device 35 are provided in order from the upstream side, which is the tank 31 side, on the fuel gas pipe 32.

The main stop valve 33 is constituted with an electromagnetic valve that opens and closes under the control of the control unit 20. The main stop valve 33 controls an outflow of fuel gas from the tank 31. The regulator 34 is a depressurizing valve, and, under the control of the control unit 20, adjusts the pressure inside the fuel gas pipe 32 on the upstream side of the supply device 35. The supply device 35 periodically opens and closes, and sends fuel gas to the fuel cell 10. The supply device 35 includes, for example, an injector, which is an electromagnetically driven on-off valve that opens and closes at a set drive cycle. The control unit 20 adjusts the supply amount of the fuel gas to the fuel cell 10 by controlling the drive cycle of the supply device 35.

The fuel gas circulation and discharge unit 40 circulates the fuel gas contained in effluent gas discharged from the anode of the fuel cell 10 to the fuel cell 10, and discharges effluent water contained in the effluent gas to the outside of the vehicle 101. The fuel gas circulation and discharge unit 40 includes an effluent gas pipe 41, a gas and liquid separation unit 42, a circulation pipe 43, a circulation pump 44, an effluent water pipe 45, and an effluent water valve 46. The effluent gas pipe 41 is connected to the anode outlet of the fuel cell 10 and the gas and liquid separation unit 42, and sends, to the gas and liquid separation unit 42, the effluent gas, on the anode side, including the fuel gas that has not been used for generating power at the anode and the effluent water.

The gas and liquid separation unit 42 separates a gas component and a liquid component from the effluent gas flowing in through the effluent gas pipe 41, and reserves the liquid component in a liquid state as the effluent water. The gas and liquid separation unit 42 is connected to the circulation pipe 43. The circulation pipe 43 connects the gas and liquid separation unit 42 and a portion downstream of the supply device 35 of the fuel gas pipe 32. Further, the circulation pipe 43 is provided with a circulation pump 44. The gas and liquid separation unit 42 sends the gas component separated from the effluent gas to the circulation pipe 43. The circulation pump 44 sends, to the fuel gas pipe 32, the gas component including the fuel gas sent to the circulation pipe 43.

The effluent water pipe 45 is connected to a reservation unit in which the effluent water of the gas and liquid separation unit 42 is reserved. The effluent water pipe 45 is provided with an effluent water valve 46 that opens and closes under the control of the control unit 20. The control unit 20 normally closes the effluent water valve 46 and opens the effluent water valve 46 at a predetermined time, such that the effluent water reserved in the gas and liquid separation unit 42 is discharged through the effluent water pipe 45 to the outside of the vehicle 101.

The oxidant gas supply and discharge unit 50 supplies, to the fuel cell 10, as the oxidant gas, oxygen contained in the air taken into the inside of the vehicle 101 via the front grille of the vehicle 101. The oxidant gas supply and discharge unit 50 includes a supply pipe 51, a compressor 52, and an on-off valve 53. The supply pipe 51 is connected to the cathode inlet of the fuel cell 10. The compressor 52 and the on-off valve 53 are provided in the supply pipe 51. The compressor 52 sends, to the cathode of the fuel cell 10 through the supply pipe 51, compressed gas obtained by compressing the air taken from the outside of the vehicle 101. The on-off valve 53 is normally in a closed state, is opened by the compression of the compressed gas sent from the compressor 52, such that the compressed gas is allowed to flow into the fuel cell 10.

The oxidant gas supply and discharge unit 50 discharges, to the outside of the vehicle 101, the effluent gas discharged from the cathode of the fuel cell 10. The oxidant gas supply and discharge unit 50 includes an effluent gas pipe 56, and a pressure regulating valve 58. The effluent gas pipe 56 is connected to the cathode outlet, and sends, to the outside of the vehicle 101, the effluent gas discharged from the cathode of the fuel cell 10. The pressure regulating valve 58 is provided in the effluent gas pipe 56, and, under the control of the control unit 20, adjusts the back compression on the cathode side of the fuel cell 10.

The fuel cell system 100 includes a first converter 81, an inverter 83, a second converter 85, and the secondary battery 86, as components that control the power supplied to the load device 110. The fuel cell 10 is connected to an input terminal of the first converter 81 via a first direct current conductor L1. Under the control of the control unit 20, the first converter 81 boosts output voltage of the fuel cell 10.

An output terminal of the first converter 81 is connected to a direct current terminal of the inverter 83 via a second direct current conductor L2. The above-described load device 110 is connected to an alternating current terminal of the inverter 83. The inverter 83 performs conversion between direct current and alternating current. The secondary battery 86 is connected to the second direct current conductor L2 via the second converter 85. The secondary battery 86 includes, for example, a lithium ion battery. The secondary battery 86 accumulates part of the power generated by the fuel cell 10 or regenerative power generated by the load device 110. Together with the fuel cell 10, the secondary battery 86 functions as a power source of the fuel cell system 100 under the control of the control unit 20. The control unit 20 controls an output current of the fuel cell 10 and the charging and discharging of the secondary battery 86 via the two converters 81, 85. Further, the control unit 20 controls the frequency and voltage of a three-phase alternating current supplied to the load device 110 via the inverter 83.

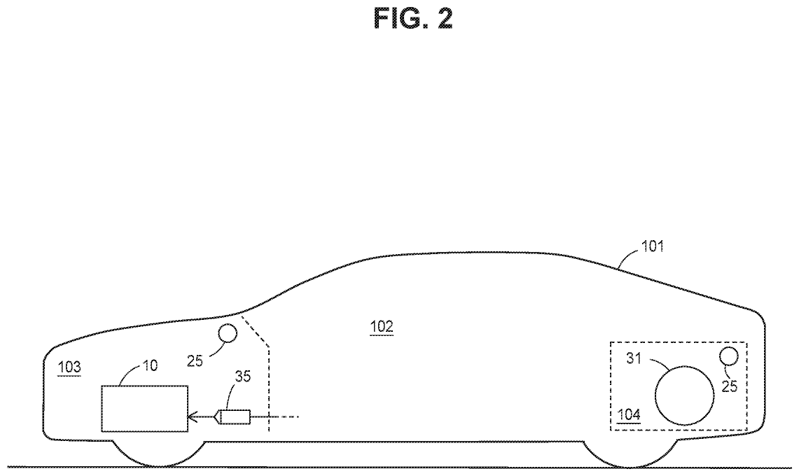

FIG. 2 is a schematic diagram illustrating the installation location of the leakage sensing unit 25 in the vehicle 101. The inside of the vehicle 101 is partitioned into a vehicle cabin 102 in which the user is boarded, a front compartment 103 in front of the vehicle cabin 102, and a rear compartment 104 behind the vehicle cabin 102. In the first embodiment, the front compartment 103 is provided with the fuel cell 10, and the supply device 35 of the fuel gas supply unit 30. Moreover, the rear compartment 104 is provided with a tank 31 of the fuel gas supply unit 30. The leakage sensing unit 25 is provided in each of the front compartment 103 and the rear compartment 104. The control unit 20 senses the fuel gas leakage in the vicinity of the supply device 35 by the leakage sensing unit 25 of the front compartment 103, and senses the fuel gas leakage in the vicinity of the tank 31 by the leakage sensing unit 25 of the rear compartment 104. In addition, in another embodiment, the leakage sensing unit 25 may be provided only in one of the front compartment 103 and the rear compartment 104. The leakage sensing unit 25 may be provided only in an installation area of the tank 31, or may be provided only in an installation area of the fuel cell 10 or an installation area of the supply device 35.

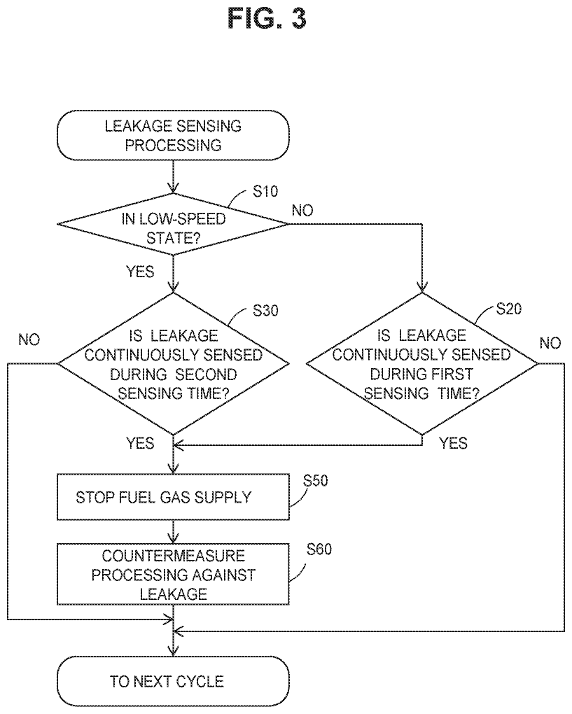

FIG. 3 is a flowchart describing a flow of the leakage sensing processing according to the first embodiment. When the user activates the vehicle 101 and the fuel cell system 100 by an activation operation, the control unit 20 repeatedly performs the leakage sensing processing at a predetermined control cycle. When the user terminates the vehicle 101 and the fuel cell system 100 by a termination operation, the leakage sensing processing is repeated until the operation of the vehicle 101 and the fuel cell system 100 is stopped.

In step S10, the control unit 20 performs a vehicle speed determination for determining whether or not the vehicle 101 is currently in a low-speed state. The control unit 20 acquires the current speed of the vehicle 101 from the speed detection unit 22, and compares the acquired speed of the vehicle 101 with a predetermined threshold speed. The control unit 20 determines that the vehicle 101 is in the low-speed state when the speed of the vehicle 101 is equal to or less than the threshold speed, and determines that the vehicle 101 is not in the low-speed state when the speed of the vehicle 101 is greater than the threshold speed.

In addition, in the present specification, the low-speed state of the vehicle 101 includes a state in which the vehicle 101 is stopped at a speed of approximately 0 km/h. In the present specification, the term “approximately” means that speed A is substantially equal to speed B, and an error range between them is, for example, about 0 to 5%. Moreover, the “state in which the vehicle 101 is stopped” refers to a state in which the vehicle 101 can travel by release of the brake without the user's activation operation of the vehicle 101. The state in which the vehicle 101 is stopped does not include a state in which driving of the vehicle 101 is terminated by the user's termination operation, such that the vehicle 101 is completely stopped. In the first embodiment, the threshold speed is 0 km/h, and the control unit 20 determines that the vehicle 101 is in the low-speed state when the vehicle 101 is stopped. Further, in another embodiment, the threshold speed does not have to be 0 km/h, and, for example, may be set to a value of 0 km/h or higher and 20 km/h or less.

When determining that the vehicle 101 is not in the low-speed state, the control unit 20 determines whether or not the fuel gas leakage is continuously sensed by the leakage sensing unit 25 during a predetermined first sensing time in step S20. The first sensing time may be, for example, about 1 to 5 seconds. As described above, in the first embodiment, when the leakage sensing unit 25 senses the fuel gas concentration to be greater than the predetermined threshold value, the fuel gas leakage is sensed and the control unit 20 measures the time during which the fuel gas leakage is continuously sensed. In step S20, when the fuel gas leakage is continuously sensed during the first sensing time, the control unit 20 determines that the fuel gas leakage requires a countermeasure, and performs the countermeasure processing in steps S50 and S60. Moreover, in the first embodiment, when the fuel gas leakage is continuously sensed in at least one of a plurality of leakage sensing units 25 during the first sensing time, the control unit 20 performs the processing of steps S50 and S60.

In step S50, the control unit 20 stops the fuel gas supply to the fuel cell 10 by the fuel gas supply unit 30. In the first embodiment, the fuel gas supply is stopped by closing the main stop valve 33. As such, an inflow of the fuel gas from the tank 31 to the fuel gas pipe 32 is blocked, and thus progress of the fuel gas leakage is curbed. Further, in another embodiment, the fuel gas supply may be stopped by stopping power supply to the supply device 35, such that the drive of the supply device 35 is stopped. Moreover, the fuel gas supply may be stopped by both closing the main stop valve 33 and stopping the drive of the supply device 35. In addition, even after the fuel gas supply is stopped, the vehicle 101 may be kept in a state in which it can travel using the power of the secondary battery 86.

As the countermeasure processing against the fuel gas leakage, the control unit 20 performs leakage countermeasure processing in step S60 in addition to processing of stopping the fuel gas supply in step S50. As the leakage countermeasure processing, the control unit 20 performs notification processing of notifying the user of the occurrence of the fuel gas leakage via the notification unit 28. Further, as the leakage countermeasure processing, the control unit 20 performs recording processing of recording, on the storage unit 21, the occurrence of the fuel gas leakage that requires a countermeasure as error information, in a non-volatile manner. In addition, as the leakage countermeasure processing, the control unit 20 may perform processing of terminating the operation of the fuel cell system 100 or processing of prohibiting the vehicle 101 from traveling. After performing the leakage countermeasure processing, the control unit 20 terminates the leakage sensing processing of the current cycle.

In step S20, when the fuel gas leakage is not sensed by the leakage sensing unit 25, or when the time during which the fuel gas leakage is continuously sensed is shorter than the first sensing time, the control unit 20 terminates the leakage sensing processing of the current cycle as it is. Subsequently, the control unit 20 starts the leakage sensing processing of the next cycle.

In step S10, when determining that vehicle 101 is in the low-speed state, in step S30, the control unit 20 determines whether or not the fuel gas leakage is continuously sensed during a predetermined second sensing time. The second sensing time is shorter than the first sensing time. The second sensing time may be, for example, about 200 to 800 milliseconds.

In step S30, when the fuel gas leakage is continuously sensed during the second sensing time, the control unit 20 determines that the fuel gas leakage requiring a countermeasure is occurring, and performs processing of steps S50 and S60 in a manner similar to the above description. Meanwhile, when the fuel gas leakage is not sensed, or when the time during which the fuel gas leakage is continuously sensed is shorter than the second sensing time, the control unit 20 terminates the leakage sensing processing of the current cycle, and starts the leakage sensing processing of the next cycle.

As described above, in the leakage sensing processing of the first embodiment, when the vehicle 101 is in the low-speed state, whether or not the fuel gas leakage is severe is determined in a short time by using the second sensing time that is shorter than the first sensing time as the determination condition. When the vehicle 101 is in the low-speed state, there is less airflow generated by traveling in the vehicle 101, and the leaked fuel gas is likely to stay in the vehicle 101 than when the vehicle 101 is not in the low-speed state. According to the leakage sensing processing of the first embodiment, in a situation in which the leaked fuel gas is likely to stay, the countermeasure against the fuel gas leakage is performed at an earlier stage. Therefore, an occurrence of a malfunction caused by the stay of the leaked fuel gas is curbed. Specifically, in the first embodiment, in a situation in which the vehicle 101 is stopped and the leaked fuel gas is more likely to stay, the countermeasure against the fuel gas leakage is performed at an early stage. Therefore, a better effect can be achieved.

### Second Embodiment

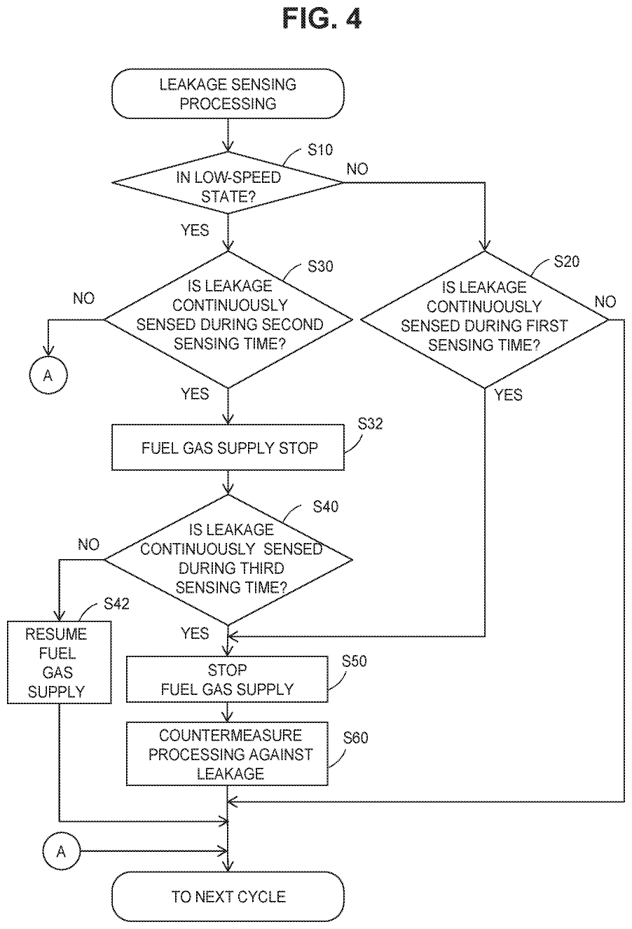

FIG. 4 is a flowchart describing a flow of the leakage sensing processing according to the second embodiment. The leakage sensing processing according to the second embodiment is performed in the fuel cell system 100, illustrated in FIG. 1, having the same configuration as the fuel cell system 100 described in the first embodiment. The leakage sensing processing according to the second embodiment is substantially the same as the leakage sensing processing according to the first embodiment except that steps S32, S40, and S42 are added. The processing after it is determined in step S10 that the vehicle 101 is not in the low-speed state is substantially the same as the processing according to the first embodiment.

When it is determined that vehicle 101 is in the low-speed state in step S10, and the fuel gas leakage is continuously sensed during the second sensing time in step S30, the control unit 20 causes the fuel gas supply unit 30 to stop the fuel gas supply to the fuel cell 10 in step S32. In the second embodiment, the control unit 20 stops the fuel gas supply to the fuel cell 10 by stopping power supply to the supply device 35 without closing the main stop valve 33. As such, the progress of the fuel gas leakage caused by the malfunction of the control of the supply device 35 and the like is curbed. In addition, at this stage, the processing of stopping the fuel gas supply is performed temporarily as an emergency measure in anticipation of a possibility that the fuel gas supply to the fuel cell 10 is resumed. This is because the fuel gas leakage sensed at this stage may be sensed erroneously by, for example, a noise signal of the leakage sensing unit 25 or may be recovered a short time later. In addition, even after the fuel gas supply is stopped, the vehicle 101 may travel using the power of the secondary battery 86.

In step S32, after stopping the fuel gas supply, in the subsequent step S40, the control unit 20 determines whether the time during which the fuel gas leakage is continuously sensed after the leakage is sensed by the leakage sensing unit 25, exceeds a predetermined third sensing time. The third sensing time is longer than the second sensing time that is the determination condition in step S30. The third sensing time may be equal to or less than the first sensing time that is the determination condition in step S20. The third sensing time may be, for example, 1 to 5 seconds. In the second embodiment, the third sensing time is equal to the first sensing time. In step S40, when the time during which the fuel gas leakage is continuously sensed by the leakage sensing unit 25 exceeds the third sensing time, the control unit 20 determines that the fuel gas leakage requiring the countermeasure is occurring, and performs processing of step S50. In step S50, the control unit 20 stops the fuel gas supply to the fuel cell 10 by closing the main stop valve 33. As such, the inflow of the fuel gas from the tank 31 to the fuel gas pipe 32 is blocked, and thus the progress of the fuel gas leakage is further curbed. The control unit 20 further performs the leakage countermeasure processing of step S60, described in the first embodiment.

In step S40, when the fuel gas leakage is not sensed before the time during which the fuel gas leakage is continuously sensed exceeds the third sensing time, in step S42, the control unit 20 causes the fuel gas supply unit 30 to resume the fuel gas supply to the fuel cell 10. This is because the fuel gas leakage sensed in step S30 is considered to have been erroneously detected as described above or have been resolved after being sensed. At this stage, the fuel gas supply to the fuel cell 10 is stopped only by stopping power supply to the supply device 35. Therefore, the fuel gas supply to the fuel cell 10 can be resumed in a simple, easy, and swift manner only by resumption of power supply to the supply device 35. As such, the fuel cell 10 can be returned to a normal power generation state, and the vehicle 101 can be driven normally using the power generated by the fuel cell 10 and the power of the secondary battery 86. After the above processing, the control unit 20 terminates the leakage countermeasure processing of the current cycle.

As described above, in the leakage sensing processing according to the second embodiment, when the vehicle 101 is in the low-speed state, determinations in two stages are performed in steps S30 and S40. According to the leakage sensing processing according to the second embodiment, a countermeasure against fuel gas leakage can be taken at an early stage based on the short-time determination using the second sensing time in step S30 as the determination condition. In addition, for example, even when an erroneous determination caused by the noise signal occurring in the leakage sensing unit 25 occurs in step S30, the occurrence of the fuel gas leakage is determined again based on the determination using the third sensing time in the subsequent step S40. Therefore, the reliability of the determination of the fuel gas leakage in the leakage sensing processing is enhanced. Moreover, in the leakage sensing processing according to the second embodiment, even when the fuel gas supply is stopped based on the short-time determination using the first sensing time, the fuel gas supply is resumed if the fuel gas leakage is not sensed after the stopping of the fuel gas supply. For this reason, a period during which drive torque of the vehicle 101 is insufficient and traveling performance of the vehicle 101 is decreased, which results from insufficient power from the fuel cell 10 due to the stopping of fuel gas supply to the fuel cell 10, is shortened. Therefore, inconvenience for the user is reduced. Further, in the leakage sensing processing according to the second embodiment, since the fuel gas supply to the fuel cell 10 can be resumed by the resumption of power supply to the supply device 35 in step S42, it is possible to return the vehicle 101 to a normal traveling state in a simple, easy, and swift manner. Therefore, the period, as described above during which the traveling performance of the vehicle 101 is decreased, is further reduced. In addition, in the leakage sensing processing according to the second embodiment, when it is determined that the fuel gas leakage occurs for a long time based on the determination using the third sensing time in step S40, processing of a countermeasure against the fuel gas leakage is appropriately performed in steps S50 and S60. Therefore, the process of the malfunction caused by the fuel gas leakage can be curbed. In addition, with the fuel cell system 100 and a method thereof according to the second embodiment, various functions and effects similar to those described in the first embodiment can be achieved.

### Third Embodiment

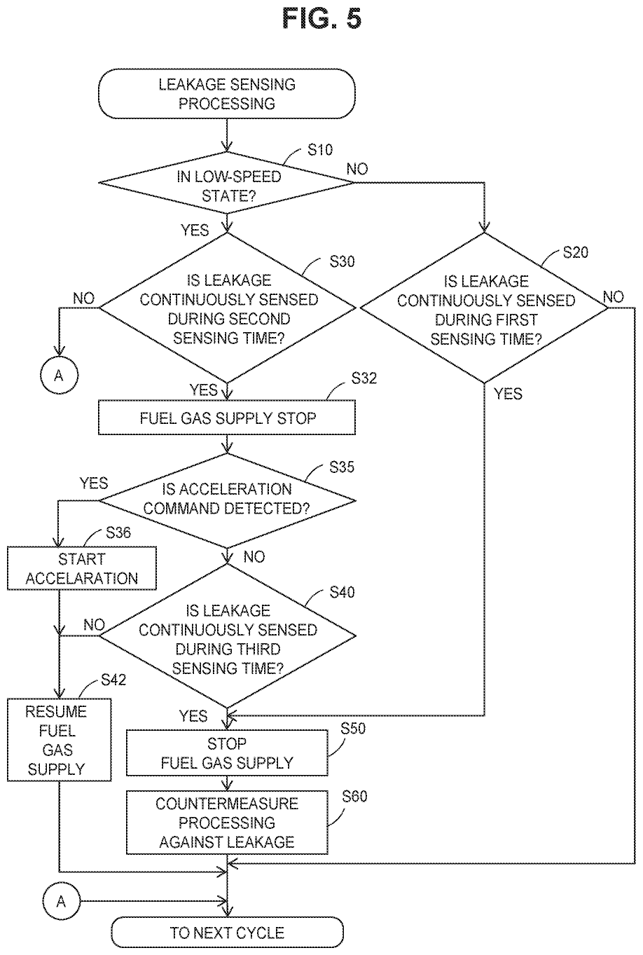

FIG. 5 is a flowchart describing a flow of the leakage sensing processing according to a third embodiment. The leakage sensing processing according to the third embodiment is performed in the fuel cell system 100, illustrated in FIG. 1, having the same configuration as the fuel cell system 100 described in the first embodiment. The leakage sensing processing according to the third embodiment is substantially the same as the leakage sensing processing according to the second embodiment except that steps S35 and S36 are added after step S32.

In the leakage sensing processing according to the third embodiment, even after the fuel gas supply is stopped in step S32 and before the determination of step S40 is performed, the fuel gas supply to the fuel cell 10 is resumed when the acceleration operation of the vehicle 101 is detected as below. When detecting the acceleration operation of the vehicle 101 by the user in step S35 before the time during which the fuel gas leakage is continuously sensed by the leakage sensing unit 25 exceeds the third sensing time, the control unit 20 starts the acceleration of the vehicle 101 using the power of the secondary battery 86 in step S36. Subsequently, in step S42, in a manner similar to the manner described in the second embodiment, the control unit 20 resumes power supply to the supply device 35 so as to resume the fuel gas supply to the fuel cell 10. As such, in addition to the power of the secondary battery 86, the power generated by the fuel cell 10 can be used for the acceleration of the vehicle 101. Therefore, the period during which the drive torque is insufficient, and thus the traveling performance of the vehicle 101 is decreased is reduced.

When the fuel gas supply is resumed, the control unit 20 starts the leakage sensing processing of the next cycle. Therefore, when the fuel gas leakage is still continuously sensed even after the acceleration of the vehicle 101, it is determined that the fuel gas leakage for a long time exceeding the first sensing time or the third sensing time is occurring in the leakage sensing processing of the next cycle. In this case, in steps S50 and S60, processing of a countermeasure against the fuel gas leakage is appropriately performed.

As described above, with the leakage sensing processing according to the third embodiment, when the stopping of the fuel gas supply in step S32 is caused by an erroneous sensing by the leakage sensing unit 25 or a minor fuel gas leakage, the vehicle 101 can be returned to its normal traveling state in a shorter period of time. In addition, with the fuel cell system 100 and a method thereof according to the third embodiment, various functions and effects similar to those described in the first embodiment and the second embodiment can be obtained.

### Other Embodiments

The various configurations described in the foregoing embodiments can be, for example, modified as below. Similar to each of the foregoing embodiments, all of the other embodiments to be described below are examples of aspects for implementing the technology of the present disclosure.

### Other Embodiment 1

The installation location of the leakage sensing unit 25 is not limited to the location described in the above embodiments. The leakage sensing unit 25 may be installed, for example, at a location where there is a joint of the fuel gas pipe 32. The leakage sensing unit 25 may be provided only at one location in the vehicle 101. The leakage sensing unit 25 may monitor the occurrence of fuel gas leakage other than the method of sensing the concentration of the fuel gas. For example, the leakage sensing unit 25 may sense the occurrence of the fuel gas leakage from the fuel gas pipe 32 by monitoring a change in compression in the fuel gas pipe 32.

### Other Embodiment 2

In each of the above embodiments, the vehicle 101 does not have to use the power generated by the fuel cell 10 for its traveling. In other words, the load device 110 to which the power generated by the fuel cell 10 is supplied, does not have to include the driving power source of the vehicle 101.

### Other Embodiment 3

In each of the above embodiments, in the processing of stopping the fuel gas supply in steps S32 and S50, the supply amount of the fuel gas may be reduced instead of stopping of the fuel gas supply to the fuel cell 10. In the leakage sensing processing according to the second embodiment and the third embodiment, the processing of stopping the fuel gas supply in step S50 after step S40 may be omitted. In this case, the leakage countermeasure processing of step S60 is performed while the fuel gas supply is stopped by stopping the driving of the supply device 35. Further, in the leakage sensing processing according to the second embodiment and the third embodiment, the control unit 20 may stop the fuel gas supply to the fuel cell 10 by closing the main stop valve 33 in step S32.

### Other Embodiment 4

In the leakage sensing processing according to each of the above embodiments, as a countermeasure against the sensed fuel gas leakage, when the fuel gas supply is stopped, the control unit 20 may change the method of stopping the gas supply depending on the location where the fuel gas leakage is sensed. For example, when the fuel gas leakage is sensed by the leakage sensing unit 25 provided in the vicinity of the supply device 35, the control unit 20 may stop the fuel gas supply by stopping the operation of the supply device 35, and when the fuel gas leakage is sensed by the leakage sensing unit 25 provided in the vicinity of the tank 31, the control unit 20 may stop the fuel gas supply by closing the main stop valve 33.

### Other Embodiment 5

In each of the above embodiments, the vehicle 101 may include a higher-level control unit that controls the operation of the vehicle 101, separately from the control unit 20 that performs the leakage sensing processing.

### Other Embodiment 6

In each of the above embodiments, the leakage countermeasure processing in step S60 may be omitted. Further, as the leakage countermeasure processing, only the notification processing by the notification unit 28 may be performed, or at least one of the processing of terminating the operation of the fuel cell system 100 without performing the notification processing by the notification unit 28 and the processing of prohibiting the vehicle 101 from traveling may be performed. In a case where the notification processing is not performed, the notification unit 28 may be omitted.

### Others

In the above embodiments, parts or all of the functions and processes implemented by software may be implemented by hardware. In addition, parts or all of the functions and processes implemented by hardware may be implemented by software. As the hardware, for example, various circuits, such as an integrated circuit, a discrete circuit, or a combined circuit module thereof can be used.

An applicable embodiment of the present disclosure is not limited to the foregoing embodiments, examples, and modifications, and may be implemented with various configurations within a range not departing from the scope of the present disclosure. For example, the technical features in the embodiments, examples, and modifications corresponding to the technical features of each aspect described in the SUMMARY can be appropriately replaced or combined. Moreover, the technical features may be appropriately deleted in a case where they are not described as essential in the present specification as well as in a case where they are described in the present specification as being inessential.

What is claimed is:

1. A fuel cell system mounted on a vehicle, the fuel cell system comprising:
a fuel cell configured to generate power by receiving a fuel gas and an oxidant gas;
a fuel gas supply unit configured to supply the fuel gas to the fuel cell;
a leakage sensor configured to sense leakage of the fuel gas;
a speed detector configured to detect a speed of the vehicle; and
a control device configured to control the fuel gas supply unit, wherein the control device is configured to perform leakage sensing processing including:
in a case where the speed of the vehicle is greater than a predetermined threshold speed, stopping a supply of the fuel gas to the fuel cell, or reducing a supply amount of the fuel gas to the fuel cell when the leakage of the fuel gas is continuously sensed during a predetermined first sensing time; and
in a case where the speed of the vehicle is equal to or less than the threshold speed, stopping the supply of the fuel gas to the fuel cell, or reducing the supply amount of the fuel gas to the fuel cell when the leakage of the fuel gas is continuously sensed during a predetermined second sensing time, the second sensing time being shorter than the first sensing time.

2. The fuel cell system according to claim 1, wherein the control device is configured to resume, after stopping the supply of the fuel gas to the fuel cell when the speed of the vehicle is equal to or less than the threshold speed and the leakage of the fuel gas is continuously sensed during the second sensing time, the supply of the fuel gas to the fuel cell in a case where the leakage of the fuel gas is not sensed before the time during which the leakage of the fuel gas is continuously sensed exceeds a predetermined third sensing time, the third sensing time being longer than the second sensing time.

3. The fuel cell system according to claim 2, further comprising a notification device configured to notify a user of an occurrence of the leakage of the fuel gas,
wherein the control device is configured to perform, after stopping the supply of the fuel gas to the fuel cell when the speed of the vehicle is equal to or less than the threshold speed and the leakage of the fuel gas is continuously sensed during the second sensing time, leakage countermeasure processing that includes processing of causing the notification device to notify the occurrence of the leakage of the fuel gas in a case where the time during which the leakage of the fuel gas is continuously sensed exceeds the third sensing time.

4. The fuel cell system according to claim 3, wherein the leakage countermeasure processing includes processing of terminating an operation of the fuel cell system.

5. The fuel cell system according to claim 2, further comprising a secondary battery configured to store part of the power generated by the fuel cell,
wherein the control device is configured to:
detect an acceleration operation of the vehicle by a user;
perform an operation control for supplying the power in response to the acceleration operation from at least one of the fuel cell and the secondary battery, to a driving power source of the vehicle;
repeatedly perform the leakage sensing processing at a predetermined control cycle during the performance of the operation control; and
after stopping the supply of the fuel gas to the fuel cell when the speed of the vehicle is equal to or less than the threshold speed and the leakage of the fuel gas is continuously sensed during the second sensing time, resume the fuel gas supply to the fuel cell in a case where the acceleration operation is detected before the time during which the leakage of the fuel gas is continuously sensed exceeds the third sensing time, to supply the power in response to the acceleration operation to the driving power source and accelerate the vehicle.

6. The fuel cell system according to claim 2, wherein:
the fuel gas supply unit includes a tank that stores the fuel gas, a main stop valve that controls an outflow of the fuel gas from the tank, and a supply device that adjusts the supply amount of the fuel gas to the fuel cell, the supply device being provided at a downstream side of the main stop valve;
the control device is configured to:
when the speed of the vehicle is greater than the threshold speed and the leakage of the fuel gas is continuously sensed during the first sensing time, stop the supply of the fuel gas to the fuel cell by closing the main stop valve; and
when the speed of the vehicle is equal to or less than the threshold speed and the leakage of the fuel gas is continuously sensed during the second sensing time, stop the supply of the fuel gas to the fuel cell by stopping operation of the supply device without closing the main stop valve.

7. The fuel cell system according to claim 1, wherein a state in which the speed of the vehicle is equal to or less than the threshold speed is a state in which the vehicle is stopped, and a state in which the speed of the vehicle is greater than the threshold speed is a state in which the vehicle is traveling.

8. A method of controlling a fuel cell system, wherein the fuel cell system is mounted on a vehicle, and includes a fuel cell configured to generate power by receiving a fuel gas and an oxidant gas, a leakage sensor configured to sense leakage of the fuel gas, a speed detector configured to detect a speed of a vehicle, and a control device configured to control supply of fuel gas to the fuel cell, the method comprising:
detecting, by the speed detector, the speed of the vehicle;
sensing, by the leakage sensor, the leakage of the fuel gas;
in a case where the speed of the vehicle is greater than a predetermined threshold speed, by the control device, stopping the supply of the fuel gas to the fuel cell or reducing a supply amount of the fuel gas to the fuel cell when the leakage of the fuel gas is continuously sensed during a predetermined first sensing time; and
in a case where the speed of the vehicle is equal to or less than the threshold speed, by the control device, stopping the supply of the fuel gas to the fuel cell or reducing the supply amount of the fuel gas to the fuel cell when the leakage of the fuel gas is continuously sensed during a predetermined second sensing time, the second sensing time being shorter than the first sensing time.
